(19) United States
(12) Patent Application Publication
(10) Pub. No.: US 2006/0214911 A1
(43) Pub. Date: Sep. 28, 2006

(54) Pointing device for large field of view displays

(75) Inventor: Michael E. Miller, Honeoye Falls, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 11/087,521

(22) Filed: Mar. 23, 2005

(51) Int. Cl. G09G 5/08

(52) U.S. Cl. 345/157

(57) ABSTRACT

An interactive system for improving cursor positioning on a display comprising a screen or series of screens having a field of view of greater than 30 degrees with respect to a user, wherein the system includes: a user controlled input device for positioning a cursor on the display; a means for determining the relative location and orientation of the user's head with respect to the display; and a cursor repositioning means for determining an implied region of interest on the display based on the relative location and orientation of the user's head and moving the cursor to a selected position within the implied region of interest.

### FIELD OF THE INVENTION

The present invention relates to computer human user interface. Particularly, the invention provides an enhanced pointing device behavior for computer workstations having large field of view displays.

### BACKGROUND OF THE INVENTION

Pointing devices, including mice, trackpads, trackballs and other devices, such as the IBM TrackPoint; currently provide the preferred method for a human to control the position of a cursor within a graphical computer interface. These devices have been optimized to provide the ability to select small regions, such as a checkbox, within a computer interface while also allowing the user to quickly move the cursor quickly across a display surface. To allow both functions, the control-display ratio of these devices has been finely tuned to allow both fine motor control required for object selection and quick cursor movement required to quickly move the cursor across the display. The control-display ratio is the ratio of the distance of movement of the cursor on the display screen to a human input to the object. In devices such as a mouse, trackball or trackpad, the control-display ratio is the ratio of the distance of movement of the cursor on the display screen to the distance of movement of the human hand while in contact with the device. However, this ratio may also refer to the distance of movement of the cursor on the display screen to the force applied in the example of a TrackPoint.

Generally, the use of a small control-display ratio provides the user the ability to make very fine movements of the cursor while the use of a large control-display ratio allows the cursor to be moved quickly across the display surface. Even with relatively small display surfaces, such as the 17 to 19 inch displays that are commonly used today, it is difficult to establish a single control-display ratio that allows both the resolution of control necessary to select items in today's operating systems and yet allow the user to quickly move the cursor the entire diagonal of the display device. To overcome this issue, strategies, such as increasing the control-display ratio as a function of force or speed of movement of the input device, have been developed to allow these devices to be used reasonably well with today's displays. However, as the display surface becomes larger it becomes more difficult to simply adjust the control-display ratio to accommodate both the fine control required for selection and still allow the cursor to be moved with a small movement from the bottom right to the top right of a display.

It is worth noting that requiring the user to make multiple mouse or other input device movements to move the cursor from one area of a display to another area of the display is undesirable for at least two reasons. The first of these is the simple loss of productivity that occurs since the user spends more time making multiple movements to move the cursor from one side to the other of the display. The second of these is an increase in repetitive motions that will increase the potential for increased biomechanical stress and may lead to a further increased incidence of repetitive motion disorders, such as carpal tunnel syndrome.

The problem of enabling fine cursor control with fast cursor movement will become significantly more important as larger desktop panoramic displays, such as the display discussed by Starkweather in U.S. Pat. No. 6,813,074 and entitled “Curved-screen immersive rear projection display” are developed and become available on the desktop or as users begin to increase the effective display size by using multiple display screens. In fact, one of the primary reasons for the adoption of large field of view displays is to improve productivity as discussed by Czerwinski et al, “Toward characterizing the productivity benefits of very large displays” In M. Rauterberg et al. (Eds.), Human-Computer Interaction—INTERACT '03, IOS Press, 9-16. Copyright IFIP, 2003. However, this improvement in productivity may be further improved with improvements in input device technology that overcome the problem of enabling fine and yet fast cursor control.

Various strategies may be employed to improve the ability to quickly move the cursor across a large display surface. One of these is to select an alternative input technique, such as a gestural interface as described by Holzrichter et al. in U.S. Pat. No. 6,738,044 entitled “Wireless, relative-motion computer input device” which are better suited to large movements. Unfortunately, these input techniques generally do not provide a mechanism for fine control of a cursor. Perhaps a more preferred method of improving common input devices is to determine the user's focus of attention when using a common input device and to provide a discontinuous movement of the cursor in response to information regarding the user's focus of attention.

One such method for accomplishing this using a relatively small field of view display has been discussed by Amir et al. in U.S. Pat. No. 6,204,828 entitled “Integrated gaze/manual cursor positioning system”. Amir et al. discuss the combined use of an eye gaze tracker coupled with a traditional input device. Within the embodiment provided by this patent, a gaze tracker is used to determine the point of attention of the user by determining the exact point on the display screen at which the user is looking. When the user activates the traditional input device, the cursor is moved to the location of the point of gaze, ideally eliminating the need for at least large, if not all, cursor movements using the traditional input device.

While the method proposed by Amir et al. accomplishes the task of determining the user's attention, potentially eliminating the need for large mouse movements, this method has a number of significant technical barriers since tracking the user's point of gaze requires the exact determination of the user's eye with respect to the display surface within three-dimensional space as well as the exact orientation of the user's eye. Due to the difficulty of implementation of a robust eye gaze tracking system, these systems remain a topic of research and systems that are commercially available are sold for tens of thousands of dollars. Further, the systems that are commercially available require the user to undergo a process to calibrate the gaze tracking system and these calibrations are not stable, requiring recalibration with significant changes in lighting, posture, or other environmental variables. Further within these systems, the determination of at least the eye's orientation is typically performed using video tracking, which makes it important that the system include either a high resolution sensor or a lower resolution sensor with fast mechanical tracking, each of which add expense to the system. Further, the front surface of the human eye must always be visible to the video tracking system. Therefore systems that are known today, which employ a single gaze tracking camera, requires that at least one, if not both, of the user's eyes to be visible to the camera in order to track the eye. Therefore, systems such as the one described by Amir et al. may only function on displays having a limited field of view.

In addition to the technical barriers present when using gaze-tracking devices, it is well understood that due to differences between eye shapes and sizes that gaze tracking systems require each individual to calibrate the systems to provide accurate tracking. This requirement, coupled with the fact that, as noted earlier, this calibration is often not robust with changes in environmental variables, may actually lead to a decrease in productivity and user satisfaction as the user is burdened with calibration and recalibration of the gaze tracking system.

There is a need therefore for a method of human computer input apparatus and method that allows the user to make fine cursor movements and at the same time to quickly make large cursor movements without repetitive movements of the input device. Ideally the solution will allow the human to utilize the input device he or she is already comfortable using, be provided at a low cost and not require the user to perform ancillary tasks, such as calibration.

### SUMMARY OF THE INVENTION

The present invention is directed to an interactive system for improving cursor positioning on a display comprising a screen or series of screens having a field of view of greater than 30 degrees with respect to a user, wherein the system includes: a user controlled input device for positioning a cursor on the display; a means for determining the relative location and orientation of the user's head with respect to the display; and a cursor repositioning means for determining an implied region of interest on the display based on the relative location and orientation of the user's head and moving the cursor to a selected position within the implied region of interest.

### BRIEF DESCRIPTION OF THE DRAWINGS

FIG. 1 provides a schematic diagram of system components useful in practicing the invention.

FIG. 2 provides a flow chart depicting a process useful in practicing the invention.

FIG. 3 provides a user interface window to allow selection of an alternative user when applying the current invention.

### DETAILED DESCRIPTION OF THE INVENTION

This invention takes advantage of the fact that a human operator generally moves his or her head in concert with eye movements whenever significant shifts in attention occur in order to provide improved cursor positioning. As described by A. R. Tilley in the book entitled “The Measure of Man and Women” published by Henry Dreyfuss Associates, New York, 1993, users generally find eye rotation to plus or minus 15 degrees off center to be easy. The user will make larger eye movements, however, head movements will typically accompany these eye movements. Eye movements beyond plus or minus 35 degrees can not be made, requiring that the user rotate his or her head to gather visual information. It is generally more comfortable for a user to maintain their eyes pointed straight ahead than to look to the side. For this reason, the user may make head movements even when eye movements of 15 degrees or less are required.

The fact that eye movements, especially those beyond plus or minus 15 degrees, are likely to be followed by head movements, enables one to determine the approximate region to which a human operator is attending by tracking only the approximate location and orientation of the computer user's head. Knowledge of this region of attention may then be employed within a human-computer interface having a large field of view display to reduce the amount of motion or force applied to a user input device in order to make large cursor movements. Specifically, a system may be developed that includes a user controlled input device for positioning a cursor on the display; a means for determining the relative location and orientation of the user's head with respect to the display; and a cursor repositioning means for determining an implied region of interest on the display based on the relative location and orientation of the user's head and moving the cursor to a selected position within the implied region of interest.

In such a system, the location and orientation of a user's head may be ascertained using a means such as a video camera with head detection and orientation determination software. This location and orientation information may be used to determine the user's region of attention. When the cursor position is outside the region of attention by some margin, the cursor may be moved to lie in or near this region of attention, thereby reducing the amount of movement or force the user needs to apply to the input device to accomplish a large cursor movement. This cursor movement may occur automatically or may occur in response to a user action, i.e. each time the user moves or applies force to a traditional computer input device, such as a mouse. In this invention, it is further possible to store previous cursor locations within each region of attention and to restore the cursor to a previous location, which potentially improves the user's ability to locate the cursor position and further reduces the required cursor movement.

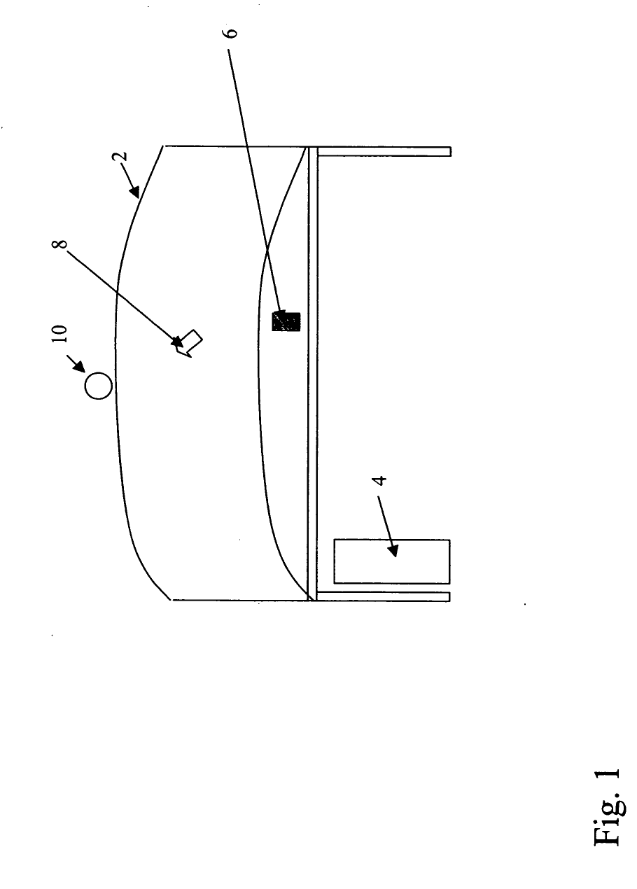

FIG. 1 depicts a workstation layout in which the system of the present invention may be useful. Note that the workstation layout consists of a large field of view display 2, a cursor repositioning means such as computer 4, a user input device 6, such as a mouse, a cursor 8 indicating a pointing location on the display screen and a means to determine the location and orientation of the user's head with respect to the display system, such as video camera 10. In this workstation, the display 2 will typically be any interactive display large enough to fill more than 30 degrees of the user's field of view, such that the user will generally make head movements, as opposed to eye movements, to see information at different regions of the display. The display 2 may be flat or provide a curved image to the user and may be composed of a single screen or a combination of two or more display screens that are controlled to provide a single interactive environment which allows the cursor to be moved from one screen to another screen. The invention is particularly suitable for use with wide screen displays (e.g., those having a width to height ratio of greater than 16:9, and especially panoramic displays having ratios greater than 2.6:1), and even more particularly for curved wide-screen displays, where users will be more apt to turn their heads beyond a field of view of greater than 30 degrees to view the whole display. The computer 4 will be any device capable of rendering and controlling a cursor on the display 2. The input device 6 will be any user input device that may be intentionally controlled by the user to control the location of the cursor 8 on the display 2. Examples of an input device 6 useful in practicing the invention include mice, trackballs, trackpads, and trackpoints. The cursor 8 may be any visible cue that is provided on the display to indicate the location that will be acted upon if the user performs an action, such as pressing a mouse button.

While a video camera 10 is depicted, since only the location and the orientation of the head with respect to the display device must be determined to practice this invention, any means for detecting head location and orientation with respect to the display screen may be employed. Ideally such a device would not require the user to wear any device, however, instruments such as the Flock of Birds, Real-time, magnetic motion-tracking device sold by Ascension Technology Corporation may be used to determine head location and orientation with respect to the display system. Information from any such device may be utilized to determine the region of interest. In a video camera embodiment, one or more, relatively low resolution video cameras may be employed that are, for example, integrated into the display to image the area in front of the display system, including the head of any user who is seated to view the display system. Image processing software may be employed to determine the relative location and orientation of the user's head with respect to the display system. Knowing the relative location and orientation of the head then allows the determination of the region of interest as necessary to practice this invention.

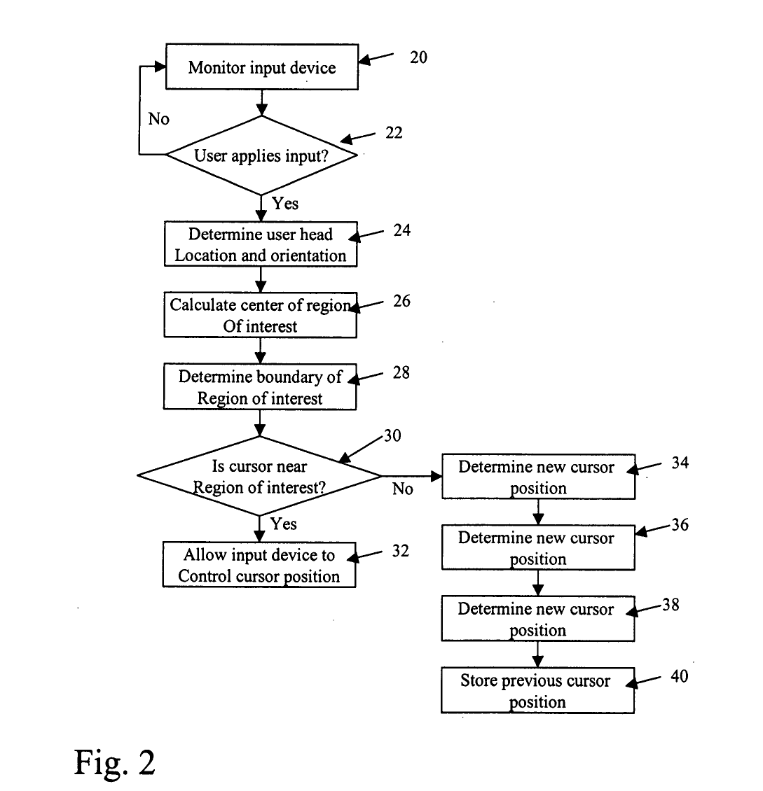

FIG. 2 shows a process useful in practicing the current invention. As shown in this Figure, the computer monitors 20 the input device to determine any instant in time the user applies an input to the device. At the same time, the system monitors 22 the user's head position and orientation. On a periodic basis the computer determines 24 whether the user has applied an input to the input device, if the user has not, the computer continues monitoring 20 the input device, as well as monitoring 22 the user's head position and orientation.

When computer determines 24 that an input has been applied to the input device, the user's head position and orientation with respect to the display is used to calculate 26 the approximate center of a region of interest. The boundary of the region of interest on the display is then determined 28. In one embodiment, the region of interest may be determined by simply defining a fixed horizontal and vertical dimension for the region of interest and calculating the corners of the region of interest based upon this dimension. However, one may recognize that other methods, such as determining if the region of interest falls within a single screen or window within the user interface and defining the relevant window or screen as the region of interest may also be used.

The computer then determines 30 if the cursor is within a tolerance of being within the region of interest. If the cursor is already within a defined tolerance of being within the region of interest, the cursor is not moved in a discontinuous fashion in response to head movement. Instead the input device is allowed 32 to control the behavior of the cursor. The tolerance may be defined by the user or may be dependent upon the accuracy of the head tracking system.

If the cursor position is outside the defined tolerance of being within the region of interest, a new cursor position is determined 34. The new cursor position may be determined by the cursor repositioning means (e.g., computer 4) in any number of ways. However, one particularly desirable method is to first determine if the cursor was moved from the new region of interest within one of the last few times that the cursor was repositioned in response to head location and orientation. If it was, then it is likely that the user is moving between two or three work areas (i.e., spreadsheet columns, documents, or other desktop application) and wishes to return to the same cursor location as he or she used before the cursor was repositioned in response to head location and orientation. In this instance, the cursor position that was last used within the region of interest may be recalled from memory and used as the new cursor position. If the cursor was not moved from the region of interest within one of the last few times that the cursor was repositioned in response to head location and orientation, then the new cursor location may be calculated by determining the intersection of a line drawn from the current cursor location to the center of the region of interest with the boundary of the region of interest. Once the new cursor position is determined, the computer writes 36 the screen coordinates of the new cursor position into the coordinates for the cursor, and moves 38 the cursor to the new cursor position. The previous active cursor position is stored 40 in memory, to allow the user to return to this exact cursor location at a later point in time. The computer then allows 32 the input device to complete the cursor location. The computer determines 42 when the user has completed cursor movement with the input device, completing the cursor movement. The computer once again returns to monitoring the input device 20 and monitoring 22 the location and orientation of the user's head.

The computer system may additionally select a window within the region of interest to make it the active window. The window selection may be made any time a window is near the center of the region of interest or only when the user seems to be returning their cursor to a recently used application (i.e., when the cursor is returned to a location from which it was recently moved through a head movement).

When determining the center of the region of interest, one may simply assume that this point on the display device occurs at the intersection of a line which emanates from a point between the user's eyes and that is perpendicular to a plane drawn parallel to the front of the user's brow and their chin or other facial landmarks. However, it should be recognized that while such a fixed description may be useful, individual variability may occur between users for many reasons. For example, the extent of facial features varies from individual to individual. Another reason for variability may occur due to the use of glasses. For example, individuals wearing bifocals may position their head very different when seated close to the display device than when seated further from the display device. For this reason, it may be additionally useful to calibrate the desired center of the region of interest for each user as a function of head location and orientation. Such a calibration may be provide in either a training mode, requiring specific action by the user or in a learning mode in which the computer learns based on user actions.

The user may initiate a training mode. In such a mode, the display system may display a number of calibration targets onto the display screen in a time sequential fashion. As the user looks at each of the calibration target, he or she may press a key on an input device to allow the computer to associate their current head position with the center of the region of interest indicated by the location of the target. Typically, calibration targets may be displayed to the user at the corners and the center of the display, as well as a few intermediate points. The user may also be instructed to change their viewing distance during the calibration to allow the system to understand the desired relationship of center of the region of interest as a function of head location and orientation.

While such a training mode allows the computer to quickly learn the desired relationship between the center of the region of interest and head location and orientation, it does require the user to take specific actions outside of his or her day-to-day activities. To overcome this problem, the computer may operate in a learning mode. In this mode, it is to be understood that experiments conducted by the inventor demonstrate that users typically look specifically at the cursor when selecting an item on the display through a mouse click or similar activation signal. As a result, head location and orientation may be recorded together with cursor position at the time the user selects an icon or similar small graphic feature using the input device. The resulting information provides a rich database, which may be used to determine the relationship of the center of the region of interest as a function of head location and orientation. Optimization techniques may then be employed to fit a relationship describing the center of the region of interest as a function of head location and orientation. Such a technique has the further advantage that users are not aware that the system is learning from their behavior and will behave naturally rather than in a contrived manner as they may when operating in training mode. The process shown in FIG. 2 may then be adapted based upon this calibration, which describes the relationship of the center of the region of interest as a function of head location and orientation by applying this function as a sub step within step 26.

It should also be noted that additional calibration information may be required. For example, when using a magnetic head tracking device, the device typically consists of two components, one for emitting a signal and the other for receiving the signal. In such a system, the distance between the source and the receiver are known and therefore relative position and orientation between the two devices are measured. However, to apply this information within the current invention, location and orientation must be known with respect to a point on the display device. Therefore offset information for location and orientation of the position of the reference device (typically location of the source or receiver) to a point on the display device must be known. Under these circumstances, it may be necessary to enter this data into the computer. One simple method of entering this data into the computer is to provide a reference point on the display system. Once the magnetic head tracker is attached to the computer, a calibration may be performed simply by placing the unit that is moved with the user's head in contact with the reference point on the display device, aligning it to a prescribed orientation and pressing a key on the keyboard. The computer may then record the relative location and orientation with respect to the reference point. While similar offset information must be provided for all devices that are detached from the display system, it is possible to embed some devices, such as digital video cameras, into the display or the bezel of the display device such that they have a fixed location with respect to the display. Under these conditions the reference point provided by the cameras may be stored within the display information and may not need to be provided by the user.

As mentioned earlier, while any head-tracking device that allows one to determine head location and orientation may be used to practice the current invention, it may be desirable to use a video head tracker to perform this function. It is known in the art to determine relative head location and orientation with respect to one or more video cameras using software algorithms. For example, Edwards and Nguyen in U.S. Pat. No. 6,545,706 entitled “System, method and article of manufacture for tracking a head of a camera-generated image of a person” provides a method segmenting the head of a person from a static environment and tracking the location of the head. While many processes may be used to segment and determine the location of a user's head, such a process will often include the subtraction of a background to find objects that have moved into the view of the camera, segmentation and selection of likely heads through processes that include determination of flesh color, matching and segmentation of candidate regions based on general shape, size, and location and tracking of these regions to determine changes in position and orientation.

It should be noted that most systems for tracking head location using video images provide relative horizontal and vertical information but often do not provide viewing distance information. In this case, viewing distance may be ascertained from the fact that the human head has an approximate size and that the size of the digital image of a human head will change with viewing distance. Therefore, viewing distance is directly proportional to the size of the head within a digital video signal. In systems employing two or more cameras, it is possible to identify the same feature point (e.g., the end of the user's nose) and knowing the relative location of the two cameras, triangulate the distance to that feature point.

It is further known in the art to determine the orientation of objects; including heads. For example, Toyama in U.S. Pat. No. 6,741,756, entitled “System and method for estimating the orientation of an object” provides a method for determining the orientation of an object such as a human head from a properly segmented video image. In this method, a trained model of the object is provided. This trained model is produced by extracting unique features from a set of training data, projecting the features of the training data onto corresponding points of a model and determining a probability density function for each model point. When analyzing the image, unique features of the object of interest are extracted from the image and back projected onto points of the trained model such that a best match is used to estimate the orientation of the object.

It should further be noted that if the display is small enough or if enough cameras are used, it may be possible to view the user's face from one or more of the cameras. In such a case, the face of the user may be tracked. The location of faces within a digital image has been discussed by Chen et al., in US Patent Application 20040179719, entitled “Method and system for face detection in digital images” and for determining the orientation of the faces as discussed by Chen et al. in US Patent Application 20040151371, entitled “Method for face orientation determination in digital color images”, the disclosures of each of which are incorporated herein by reference. It should be noted that a critical component of the method for face orientation determination is the determination of facial feature points. These facial feature points may include, e.g., points along the top and bottom of the eyes, top and bottom of the lips, the end of the nose, and the outline of the face.

Referring back to FIG. 1 the display system 2 and the means to determine the location and orientation of the user's head with respect to the display system 10 are depicting as being in the front of the observer. In the instance wherein the means to determine the location and orientation of the user's head with respect to the display system is one or more digital video cameras, these cameras may be built either into the bezel of the display or potentially formed on the same silicon substrate as the display device. In a system where this is the case, the display system may additionally contain a processor for receiving the digital video image sequence or sequences from the camera or cameras. Memory may also be provided for storing an instruction set to be used by the processor to analyze the video image sequence or sequences to perform head and/or face detection, location and orientation. In such a system, analysis of the video signal may be performed within the display system and the digital video signal. as well as, the head location and orientation information may be output directly from the display to the computer. It should further be noted that when face orientation is determined through the tracking of facial feature points, these facial feature points or relative position of feature points may also be output directly to the computer for further analysis by the computer.

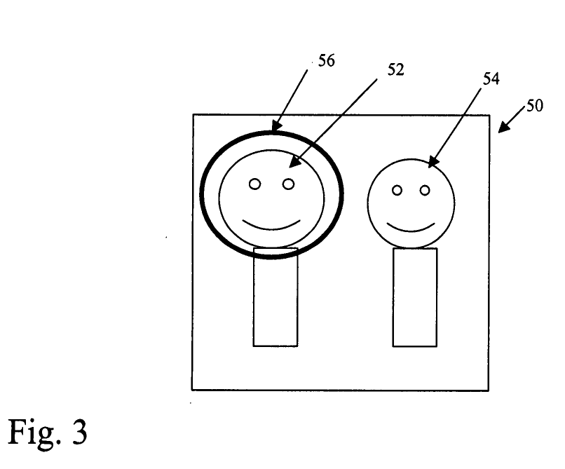

The entire discussion thus far has assumed that there is a single user in front of the display system. However, in some instances multiple faces and or heads may be present in front of the display system. Under these circumstances, the digital video system may track one or all of the heads or faces that are presented to it. However, it may not be clear which head location and orientation to use to reposition the cursor in response to location and orientation of the user's head. Under such circumstances, it is possible to apply rules, such as basing the cursor movement upon the largest head or face. However, a preferred method is to provide the user the ability to control which head to base cursor movement upon. This may be done by presenting the digital video image onto the display with a graphic indication of which user is being tracked such as is shown in FIG. 3. Shown in this figure is a window 50 that is presented on the display system 2. Shown in the window 50 is the digital video image containing the heads of two users 52 and 54. The user who's head is being used to direct cursor movement is indicated by a surrounding graphic 56. This graphic 56 clearly indicates to the user, which person the system considers as the user. To select a different person as the user, the input device may be used to indicate the other face or keys such as the arrow keys on the keyboard may be used to cycle among the faces within the window 50.

The invention has been described in detail with particular reference to certain preferred embodiments thereof, but it will be understood that variations and modifications can be effected within the spirit and scope of the invention.

### PARTS LIST

2 large field of view display
4 computer
6 user input device
8 cursor
10 video camera
20 monitor input device step
22 monitor head position and orientation step
24 determine user input step
26 calculate center of region of interest step
28 determine boundary of region of interest step
30 determine if cursor is in tolerance step
32 allow input device to control step
34 determine new cursor position step
36 write new screen coordinate step
38 move cursor step
40 store previous cursor position step
42 determine cursor movement complete step
50 window
52 head of first user
54 head of second user
56 graphic

1. An interactive system for improving cursor positioning on a display comprising a screen or series of screens having a field of view of greater than 30 degrees with respect to a user, comprising:
a) a user controlled input device for positioning a cursor on the display;
b) means for determining the relative location and orientation of the user's head with respect to the display; and
c) cursor repositioning means for determining an implied region of interest on the display based on the relative location and orientation of the user's head and moving the cursor to a selected position within the implied region of interest.

2. The system for improving cursor positioning according to claim 1, wherein the cursor repositioning means continuously automatically determines an implied region of interest on the display based on the changes in relative location and orientation of the user's head, and moves the cursor to within the implied region of interest in response to an additional user action.

3. The system for improving cursor positioning according to claim 2 wherein the additional user action includes the activation of the input device.

4. The system for improving cursor positioning according to claim 1 wherein the cursor is moved by the cursor repositioning means only when the cursor is initially outside the implied region of interest.

5. The system for improving cursor positioning according to claim 1 wherein the means for determining the relative location and orientation of the user's head includes a means for capturing a digital video image of the user's head and analysis software for determining the relative location and orientation of the user's head with respect to the display.

6. The system for improving cursor positioning according to claim 1 wherein the means for determining the relative location and orientation of the user's head includes a magnetic motion tracking device.

7. The system for improving cursor positioning according to claim 1 wherein previous cursor positions are stored, and wherein the cursor repositioning means moves the cursor to a stored previous cursor position when the implied region of interest includes the previous cursor position.

8. The system for improving cursor positioning according to claim 1 wherein the cursor repositioning means for determining an implied region of interest on the display based on the relative location and orientation of the user's head is calibrated in response to user input.

9. The system according to claim 8 wherein the cursor repositioning means is calibrated based upon the determined relative location and orientation of the user's head with respect to the display at the time of selecting items on the display using the input device.

10. The system according to claim 1 wherein the means for determining the relative location and orientation of the user's head includes locating the user's face.

11. The system according to claim 10, wherein the means for determining the relative location and orientation of the user's head includes determining selected facial features.

12. The system according to claim 1 wherein the input device for positioning a cursor on the display controls continuous movement of the cursor across the display.

13. The system according to claim 12, including a computer for controlling the continuous movement of the cursor in response to user input that is applied to the input device and that also initiates discontinuous movements of the cursor in response to the location and orientation of the head of the user.

14. The system in claim 13 wherein the means for determining the relative location and orientation of the user's head includes a digital video camera and a processing unit for analyzing the digital video images.

15. The system of claim 14 wherein the digital video camera and processing unit are embedded within the housing of the display and wherein the display outputs the location and orientation of one or more heads or faces of individuals that are viewing the display.

16. The system according to claim 14 wherein the display outputs the center of implied regions of interest for one more heads or faces of individuals that are viewing the display.

17. The system according to claim 14 wherein the display outputs the boundaries of implied regions of interest for one or more heads or faces of individuals that are viewing the display.
